(19) United States
(12) Patent Application Publication
(10) Pub. No.: US 2011/0115725 A1
(43) Pub. Date: May 19, 2011

(54) Touch Panel and Display Device Including the Same and Touch Position Detection Method of Touch Panel

(76) Inventors: Seong-Mo Hwang, Seongnam-si (KR); Nam-Hee Goo, Gunsan-si (KR); Byoung-Jun Lee, Cheonan-si (KR); Seung-Ho Nam, Seongnam-si (KR)

(21) Appl. No.: 12/784,031

(22) Filed: May 20, 2010

(30) Foreign Application Priority Data
Nov. 19, 2009 (KR) 10-2009-0112082

(51) Int. Cl. G06F 3/041

(52) U.S. Cl. 345/173

(57) ABSTRACT

A touch panel includes a first substrate and a second substrate facing each other, a plurality of first transparent resistance films formed on the first substrate and extending in a first direction, a plurality of second transparent resistance films formed on the second substrate and extending in a second direction crossing the first direction, a plurality of first signal lines respectively connected to first terminals at first ends of the plurality of first transparent resistance films, a plurality of second signal lines respectively connected to second terminals at second ends of the plurality of first transparent resistance films, a plurality of third signal lines respectively connected to third terminals at first ends of the plurality of second transparent resistance films, and a fourth signal line commonly connected to fourth terminals at second ends of at least two second transparent resistance films among the plurality of the second transparent resistance films.

### CROSS-REFERENCE TO RELATED APPLICATION

This application claims the benefit under 35 USC 119 of Korean Patent Application No. 10-2009-0112082 filed in the Korean Intellectual Property Office on Nov. 19, 2009, the entire contents of which are herein incorporated by reference in their entirety.

### BACKGROUND OF THE INVENTION

(a) Field of the Invention

The present invention relates a touch panel and a display device including the same and a contact position detecting method of a touch panel, and more particularly relates to a touch panel that is capable of a multi-touch detecting and a display device including the same and a contact position detecting method of a touch panel.

(b) Description of Related Art

Display devices are widely implemented, being used in liquid crystal displays, organic light emitting devices, portable transmitting devices, and other information processing devices. A display device executes a display function by using various input devices. One example of an input device is a touch panel.

The touch panel is a device for allowing a machine such as a computer to perform a desired command by writing a character, drawing a picture, or executing an icon through touching a finger or a touch pen (or a stylus) on a screen. A display device to which the touch panel is attached can determine whether a user finger, a touch pen, etc., touches a screen, and touch position information thereof.

Theses touch panels are generally classified as one of a resistive type, a capacitive type, and an electro-magnetic (EM) type according to the sensing method of the touch.

Among them, the resistive type touch panel includes upper and lower transparent resistance films separated from each other by a spacer. If an upper plate formed with the upper transparent resistance films is depressed by external contact such that the upper transparent resistance films and the lower transparent resistance films physically contact each other, the contact and the contact position may be determined by measuring a voltage change according to resistance of the depressed position. The resistive type of touch panel may be operated regardless of the conductivity of the contact matter, however when several positions are simultaneously touched, the values of the changed voltages are recognized as one such that it is difficult to obtain the touch information of the several positions.

Also, each transparent resistance film is connected to a signal line to be applied with a voltage or to read a voltage, and the signal lines are gathered on the edge of the touch panel such that the area of the edge region of the touch panel is increased, thereby reducing the display area. As a size of the display device increases, the number of the upper transparent resistance films and the lower transparent resistance films is increased such that the number of signal lines connected to the transparent resistance films is also increased and thereby the display area is further decreased and the edge region is widened in a given device area including the display area and the edge region.

The above information disclosed in this Background section is only for enhancement of understanding of the background of the invention and therefore it may contain information that does not form the prior art that is already known in this country to a person of ordinary skill in the art.

### SUMMARY OF THE INVENTION

A touch panel according to an exemplary embodiment of the present invention includes a first substrate and a second substrate facing each other, a plurality of first transparent resistance films formed on the first substrate and extending in a first direction, a plurality of second transparent resistance films formed on the second substrate and extending in a second direction, a plurality of first signal lines respectively connected to first terminals at first ends of the plurality of first transparent resistance films, a plurality of second signal lines respectively connected to second terminals at second ends of the plurality of first transparent resistance films, a plurality of third signal lines respectively connected to third terminals at first ends of the plurality of second transparent resistance films, and a fourth signal line commonly connected to fourth terminals at second ends of at least two second transparent resistance films among the plurality of the second transparent resistance films, wherein the first direction and the second direction cross each other.

A deviation of the voltages applied to the fourth terminal of the at least two second transparent resistance films from the fourth signal line may be equal to or less than 3%.

The fourth signal line may be connected to the fourth terminals of the plurality of second transparent resistance films.

Voltages applied to the fourth terminals of the at least two second transparent resistance films from the fourth signal line may be the same.

At least one of a deviation of resistance of the plurality of first signal lines, a deviation of resistance of the plurality of second signal lines, a deviation of resistance of the plurality of third signal lines, and a deviation of resistance of the fourth signal line may be equal to or less than 3%.

A line width of at least one of the plurality of first signal lines, the plurality of second signal lines, the plurality of third signal lines, and the fourth signal line may be less than 100 μm.

A spacer positioned between the plurality of first transparent resistance films and the plurality of second transparent resistance films may be further included.

The second substrate may comprise a transparent film.

At least one of the plurality of first signal lines, the plurality of second signal lines, the plurality of third signal lines, and the fourth signal line may comprise aluminum (Al), silver (Ag), copper (Cu), molybdenum (Mo), chromium (Cr), tantalum (Ta), and titanium (Ti).

At least one of the plurality of first signal lines, the plurality of second signal lines, and the plurality of third signal lines may be divided into a plurality of groups, and the signal lines of each group may be respectively connected to a plurality of connection circuit portions, and the fourth signal line may be divided into a plurality of portions and the plurality of portions of the fourth signal line may be respectively connected to the plurality of connection circuit portions.

The connection circuit portions may be connected to a touch controller controlling the touch panel.

A display device according to an exemplary embodiment of the present invention includes a lower substrate and an upper substrate facing each other, a plurality of first transparent resistance films formed on an outer surface of the upper substrate and extending in a first direction, the outer surface of the upper substrate not facing the lower substrate, a plurality of second transparent resistance films facing the outer surface of the upper substrate and extending in a second direction intersecting the first direction, a plurality of first signal lines respectively connected to first terminals at first ends of the plurality of first transparent resistance films, a plurality of second signal lines respectively connected to second terminals at second ends of the plurality of first transparent resistance films, a plurality of third signal lines respectively connected to third terminals at first ends of the plurality of second transparent resistance films, and a fourth signal line commonly connected to fourth terminals a second ends of at least two second transparent resistance films among the plurality of the second transparent resistance films.

A deviation of the voltages applied to the fourth terminal of the at least two of the second transparent resistance films from the fourth signal line may be equal to or less than 3%.

A first polarizer positioned on an outer surface of the lower substrate not facing the upper substrate and a second polarizer positioned on an outer surface of the second transparent resistance films not facing the outer surface of the upper substrate may be further included.

A first substrate facing the outer surface of the upper substrate may be further included, and the plurality of second transparent resistance films may be formed on the first substrate.

The plurality of second transparent resistance films may be directly formed on the second polarizer.

A liquid crystal layer or an emission layer positioned between the lower substrate and the upper substrate may be further included.

A contact position detecting method of a touch panel including a plurality of first transparent resistance films extending in a first direction and a plurality of second transparent resistance films facing the plurality of first transparent resistance films and extending in a second direction intersecting the first direction, wherein the first transparent resistance films respectively include a first terminal and a second terminal at respective ends thereof, the second transparent resistance films respectively include a third terminal and a fourth terminal at respective ends thereof, and the fourth terminals of the plurality of second transparent resistance films are commonly connected to a first signal line according to an exemplary embodiment of the present invention includes commonly applying a first voltage to the fourth terminals of the plurality of second transparent resistance films through the first signal line, detecting a detected first transparent resistance film corresponding to a first portion where a contact is applied among the plurality of first transparent resistance films, detecting a detected second transparent resistance film corresponding to the first portion among the plurality of second transparent resistance films, finding a coordinate in the first direction of the first portion; and finding a coordinate in the second direction of the first portion. The detecting of the detected first transparent resistance film may include applying a second voltage that is different from the first voltage to the first terminals of the plurality of first transparent resistance films while commonly applying the first voltage to the fourth terminals of the plurality of second transparent resistance films through the first signal line, and detecting voltages of the second terminals of the plurality of first transparent resistance films.

The detecting of the detected second transparent resistance film may include applying the second voltage to the first terminals of the plurality of first transparent resistance films while commonly applying the first voltage to the fourth terminals of the plurality of second transparent resistance films through the first signal line, and detecting voltages of the third terminals of the plurality of second transparent resistance films.

The finding of the coordinate in the second direction of the first portion may include applying a third voltage to the third terminal of the detected second transparent resistance film while commonly applying the first voltage to the fourth terminals of the plurality of second transparent resistance films through the first signal line, and detecting a voltage of the first terminal of the detected first transparent resistance films or the second terminal of the detected first transparent resistance film.

The finding of the coordinate in the first direction of the first portion may include applying a fourth voltage to the first terminal of the detected first transparent resistance film while commonly applying the first voltage to the fourth terminals of the plurality of second transparent resistance films through the first signal line, and detecting a voltage of the third terminal of the detected second transparent resistance film.

The first voltage may be a ground voltage.

The third voltage and the fourth voltage may be the same.

A deviation of voltages applied to the fourth terminals of the plurality of second transparent resistance films from the first signal line may be equal to or less than 3%.

The touch panel may include: a plurality of second signal lines respectively connected to the first terminals of the plurality of first transparent resistance films; a plurality of third signal lines respectively connected to the second terminals of the plurality of first transparent resistance films; and a plurality of fourth signal lines respectively connected to the third terminals of the plurality of second transparent resistance films.

At least one of a deviation of resistance of the plurality of second signal lines, a deviation of resistance of the plurality of third signal lines, and a deviation of resistance of the fourth signal lines may be equal to or less than 3%.

### BRIEF DESCRIPTION OF THE DRAWINGS

FIG. 1 is a perspective view of a touch panel according to an exemplary embodiment Of the present invention,

FIG. 2 is a top plan view of a lower substrate of a touch panel according to an exemplary embodiment of the present invention,

FIG. 3 a top plan view of an upper substrate of a touch panel according to an exemplary embodiment of the present invention,

FIG. 4, FIG. 5, and FIG. 7 are views sequentially showing a method for detecting a contact position when a portion of a touch panel according to an exemplary embodiment of the present invention is contacted,

FIG. 6 is an equivalent circuit diagram showing how to obtain an x coordinate of the contacted position of FIG. 5,

FIG. 8 is an equivalent circuit diagram showing how to obtain a y coordinate of the contacted position of FIG. 7,

FIG. 9, FIG. 10, and FIG. 11 are views sequentially showing a method for detecting contact positions when two portions of a touch panel according to an exemplary embodiment of the present invention are contacted,

FIG. 12, FIG. 13, and FIG. 16 are views sequentially showing a method for detecting contact positions when two portions of a touch panel according to an exemplary embodiment of the present invention are contacted,

FIG. 14 and FIG. 15 are equivalent circuit diagrams showing how to obtain an x coordinate of the contacted position of FIG. 13,

FIG. 17 is an equivalent circuit diagram to obtain a y coordinate of the contacted position of FIG. 16,

FIG. 18 is a top plan view of an upper substrate of a touch panel according to an exemplary embodiment of the present invention,

FIG. 19 is a top plan view of a lower substrate of a touch panel according to an exemplary embodiment of the present invention,

FIG. 20 is a top plan view of an upper substrate of a touch panel according to an exemplary embodiment of the present invention,

FIG. 21 is a cross-sectional view of a display panel to which a touch panel is attached according to an exemplary embodiment of the present invention, and

FIG. 22, FIG. 23, and FIG. 24 are cross-sectional views of a display panel installed with a touch panel according to an exemplary embodiment of the present invention.

### DESCRIPTION OF REFERENCE NUMERALS INDICATING ELEMENTS IN THE DRAWINGS

| | |
|---|---|
| 2: space | 4: adhesion member |
| 5: spacer | 10: lower display panel |
| 12: lower polarizer | 20: upper display panel |
| 22: upper polarizer | 30: display panel |
| 50: display area | 60: peripheral area |
| 100: lower substrate of a touch panel | 165: upper film |
| 200: upper substrate of a touch panel | 300: touch panel |
| 400: touch controller | 410, 420, 430, 440: connection |
| 150: lower transparent resistance film | circuit portion |
| 160: upper transparent resistance film | |
| 170a, 170b, 170al, 170ar, 170bl, 170br, | |
| 180a, 180b, 180bu, 180bd, 190l, 190r: | |
| signal line | |

### DETAILED DESCRIPTION OF EXEMPLARY EMBODIMENTS

The present invention will be described more fully hereinafter with reference to the accompanying drawings, in which exemplary embodiments of the invention are shown. As those skilled in the art would realize, exemplary embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

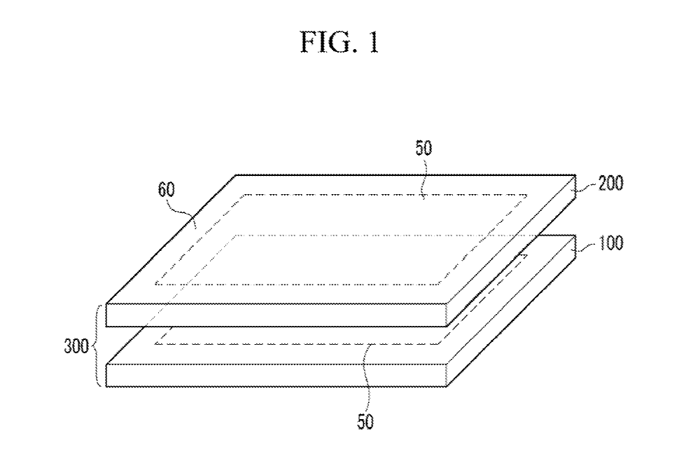

A touch panel according to an exemplary embodiment of the present invention will be described with reference to FIG. 1 to FIG. 3.

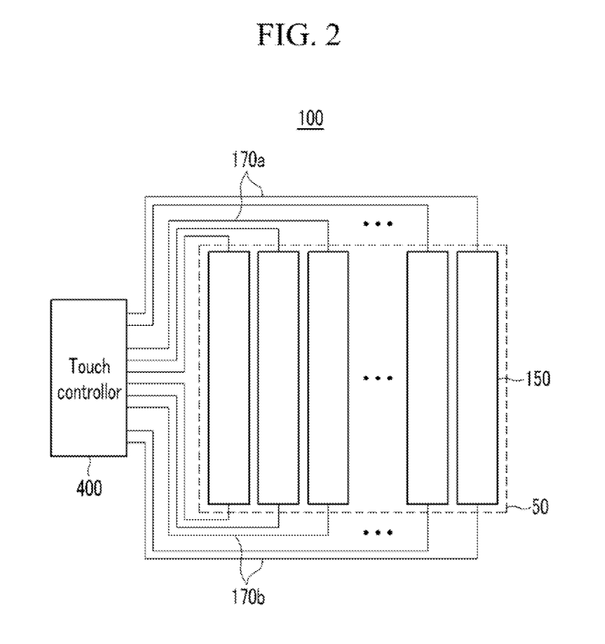

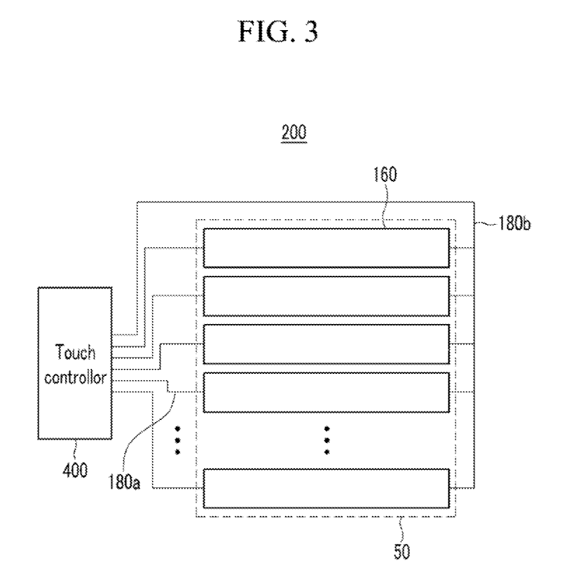

FIG. 1 is a perspective view of a touch panel according to an exemplary embodiment of the present invention, FIG. 2 is a top plan view of a lower substrate of a touch panel according to an exemplary embodiment of the present invention, and FIG. 3 a top plan view of an upper substrate of a touch panel according to an exemplary embodiment of the present invention.

Referring to FIG. 1, a touch panel 300 according to an exemplary embodiment of the present invention includes a lower substrate 100 and an upper substrate 200 facing each other, and the lower substrate 100 and the upper substrate 200 include a display area 50 and a peripheral area 60 therearound. A spacer (not shown) for maintaining an interval between the lower substrate 100 and the upper substrate 200 may be positioned between the lower substrate 100 and the upper substrate 200. Air or a fluid insulating layer (not shown) may be positioned between the lower substrate 100 and the upper substrate 200.

Referring to the lower substrate 100 with reference to FIG. 2, a plurality of lower transparent resistance films 150 are formed on a lower substrate (not shown) made of, for example, transparent glass or plastic in the display area 50. The lower substrate may include a transparent film (not shown) made of a polymer, and the lower substrate may be optically isotropic.

The lower transparent resistance films 150 extend in one direction, are substantially parallel to each other, and are separated from each other by a predetermined interval. Hereafter, a direction that the lower transparent resistance films 150 are extended is defined as a y direction in FIG. 2, and a direction perpendicular to the y direction is defined as an x direction.

Each of the lower transparent resistance films 150 includes two terminals, and in FIG. 2, an upper terminal of each lower transparent resistance film 150 is referred to as the first terminal, while the lower terminal thereof is referred to as the second terminal. The first terminal of the lower transparent resistance film 150 is connected to a touch controller 400 through a first signal line 170a, and the second terminal of the lower transparent resistance film 150 is connected to the touch controller 400 through a second signal line 170b. A portion of each of the first signal line 170a and the second signal line 170b is formed in the peripheral area 60.

Referring to the upper substrate 100 with reference to FIG. 3, a plurality of upper transparent resistance films 160 are formed in the display area 50 on an the upper substrate made of a transparent polymer. The upper substrate may be optically isotropic.

The upper transparent resistance films 160 extend in the x direction, that is, in the direction substantially perpendicular to the extending direction of the lower transparent resistance film 150, are substantially parallel to each other, and are separated from each other.

Each of the upper transparent resistance films 160 also includes two terminals, and in FIG. 3, the left terminal of each upper transparent resistance film 160 is referred to as the third terminal, while the right terminal is referred to as the fourth terminal. The third terminal of the upper transparent resistance films 160 is connected to the touch controller 400 through a third signal line 180a, and the fourth terminals of upper transparent resistance films 160 are connected to the touch controller 400 commonly through a fourth signal line 180b. A portion of each of the third signal line 180a and the fourth signal line 180b is formed in the peripheral area 60.

The lower transparent resistance films 150 and the upper transparent resistance films 160 may be made by patterning a transparent conductive material such as indium tin oxide (ITO) or indium zinc oxide (IZO) using a photolithography process. The sheet resistance of the lower transparent resistance film 150 and upper transparent resistance film 160 may be more than 100 Ω/sq to less than 1 kΩ/sq, and in detail more than 200 Ω/sq to less than 600 Ω/sq. The width of the lower transparent resistance film 150 and the upper transparent resistance film 160 may be less than 20 mm, and in detail less than 10 mm.

The first signal line 170a and the second signal line 170b may be made of a metal such as aluminum (Al), silver (Ag), copper (Cu), molybdenum (Mo), chromium (Cr), tantalum (Ta), and titanium (Ti), or alloys thereof, through patterning such as a deposition of a metal layer and photolithography process or printing such as screen printing on the lower substrate 100. The line width of the first signal line 170a and the second signal line 170b may be equal to or less than 100 μm, and in detail equal to or less than 20 μm. The first signal line 170a and the second signal line 170b have substantially the same resistance regardless of the length thereof such that if the first signal line 170a or the second signal line 170b is applied with the same voltage, substantially the same voltage drop is generated along each signal line. Therefore, substantially the same voltage may be applied to the first terminal and the second terminal of the lower transparent resistance films 150 to which the first signal line 170a and the second signal line 170b are respectively connected. The resistance deviation of the first signal lines 170a and the resistance deviation of the second signal lines 170b may be equal to or less than 3%.

The third signal line 180a and the fourth signal line 180b may be also made of a metal such as aluminum (Al), silver (Ag), copper (Cu), molybdenum (Mo), chromium (Cr), tantalum (Ta), and titanium (Ti), or alloys thereof, through patterning such as a deposition and photolithography process or printing such as screen printing on the lower substrate 100. The line width of the third signal line 180a may be equal to or less than 100 μm, and in detail equal to or less than 20 μm. The third signal line 180a has substantially the same resistance regardless of the length thereof such that if the third signal line 180a is applied with the same voltage, substantially the same voltage drop is generated along each signal line, and thereby the same voltage may be applied to the third terminal of the upper transparent resistance films 160 to which the third signal lines 180a are respectively connected. The resistance deviation of the third signal lines 180a may be equal to or less than 3%. The fourth signal line 180b, as one wire, may transmit substantially the same voltage to the fourth terminals of the upper transparent resistance films 160, and the deviation of the transmitted voltages may be equal to or less than 3%.

To equally control the resistance of the first signal lines 170a, the second signal lines 170b, and the third signal lines 180a, respectively, the width of the signal lines having the longer length may be relatively increased.

When forming the third signal line 180a and the fourth signal line 180b through a printing process such as screen printing, the line width of the third signal line 180a and the fourth signal line 180b may be limited by a minimum line width according to a process condition.

According to an exemplary embodiment of the present invention, the fourth signal line 180b of the upper substrate 200 is formed as a common wire, such that the area of the peripheral area 60 may be reduced and the display area 50 may be increased. Particularly, even when the size of the touch panel is large, the upper transparent resistance films 160 may be connected to the touch controller 400 through a common wire without increasing the number of the fourth signal lines 180b although the number of the lower transparent resistance films 150 and the upper transparent resistance films 160 is increased, such that increasing of the peripheral area 60 of the touch panel 300 may be substantially prevented and the reduction of effective panel numbers per mother glass may be substantially prevented in a manufacturing process.

The touch controller 400 may transmit input signals to or receive the output signals from the lower transparent resistance films 150 and the upper transparent resistance films 160 through the signal lines 170a, 170b, 180a, and 180b. The touch controller 400 processes the received output signals to generate the information of the contact position on the touch panel 300. This generated contact position information may be, transmitted to a display controller (not shown).

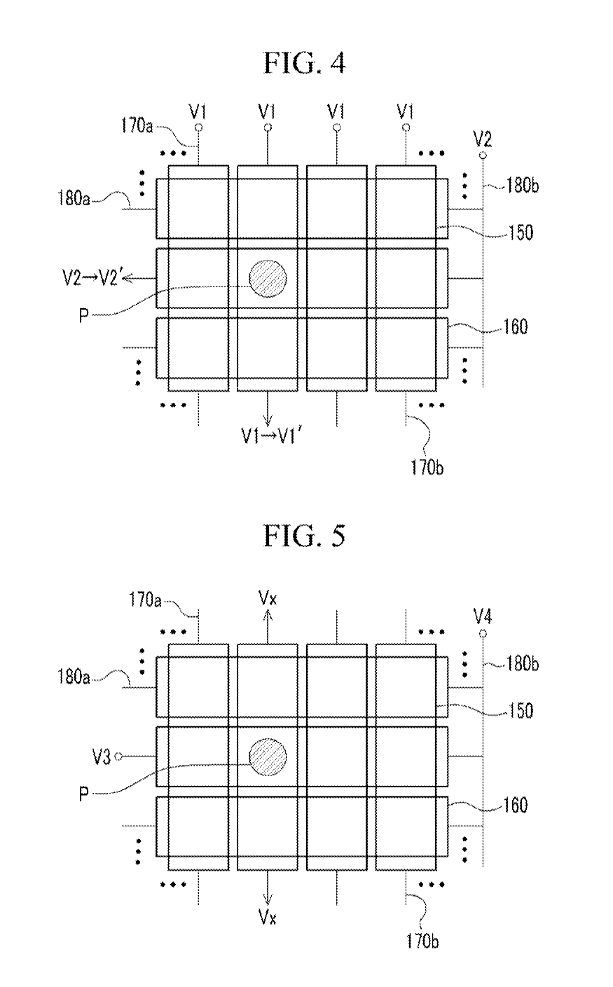

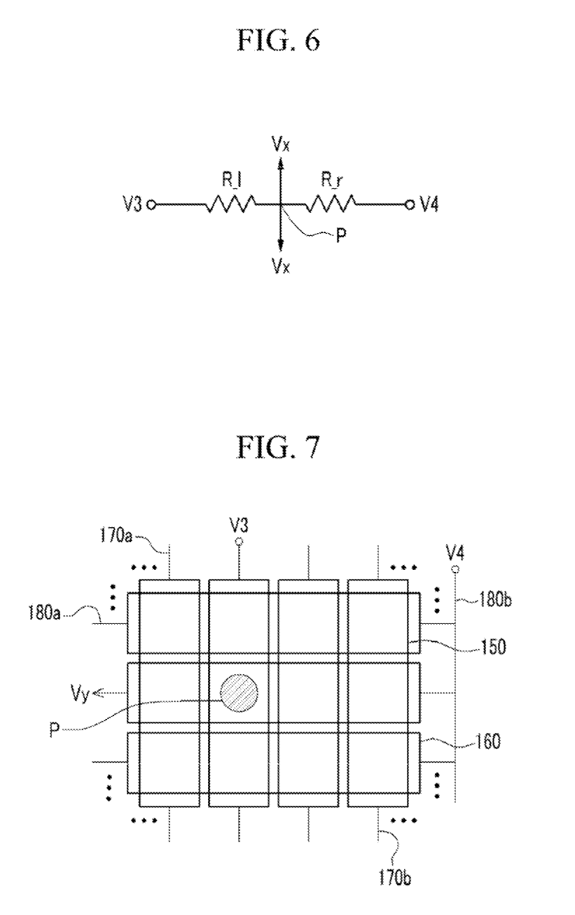

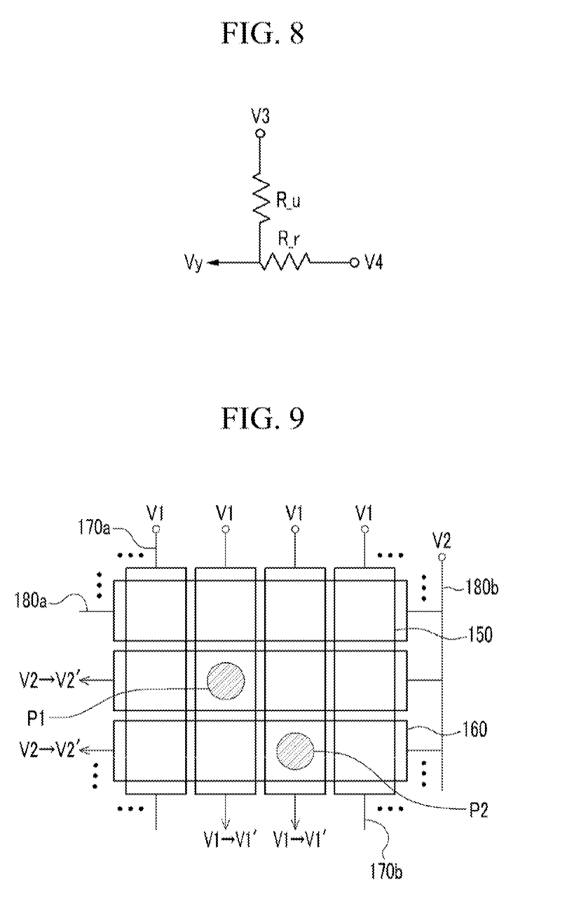

A contact position detecting method of a touch panel according to an exemplary embodiment of the present invention will be described with reference to FIG. 4, FIG. 5, FIG. 6, FIG. 7, and FIG. 8, as well as FIG. 1 to FIG. 3.

FIG. 4, FIG. 5, and FIG. 7 are views sequentially showing a method for detecting a contact position when a portion of a touch panel according to an exemplary embodiment of the present invention is contacted, FIG. 6 is an equivalent circuit diagram showing how to obtain an x coordinate of the contacted position of FIG. 5, and FIG. 8 is an equivalent circuit diagram showing how to obtain a y coordinate of the contacted position of FIG. 7.

Referring to FIG. 4, the first voltage V1 is input to the lower transparent resistance films 150 through the first signal line 170a of lower transparent resistance films 150, and the fourth terminals of upper transparent resistance films 160 receive the second voltage V2 through the fourth signal line 180b as the common wire. Here, the second voltage V2 may be a ground voltage.

If a pressure by contact is applied to one contact position P of the touch panel, the lower transparent resistance film 150 and the upper transparent resistance film 160 of the contact position P are contacted. Thus, the voltage detected through the second signal line 170b connected to the lower transparent resistance film 150 at the contact position P is the first detecting voltage V1′ that is different from the first voltage V1, and when the second voltage V2 is the ground voltage, the first detecting voltage V1′ may be a lower voltage than the first voltage V1. Also, the voltage detected through the third signal line 180a connected to the upper transparent resistance film 160 at the contact position P is the second detecting voltage V2′ that is different from the second voltage V2, and when the second voltage V2 is the ground voltage, the second detecting voltage V2′ may be a higher voltage than the ground voltage.

Accordingly, the lower transparent resistance film 150 and the upper transparent resistance film 160 corresponding to the contact position P may be detected, and they are referred to as a detected lower transparent resistance film 150 and a detected upper transparent resistance film 160. Differently from an exemplary embodiment of the present invention, the functions of the first signal line 170a and the second signal line 170b may be exchanged.

Referring to FIG. 5, the third signal line 180a connected to the detected upper transparent resistance film 160 is applied with the third voltage V3, and the fourth signal line 180b is applied with the fourth voltage V4. Here, the third voltage V3 may be the same as the first voltage V1, and the fourth voltage V4 may be the same as the second voltage V2 or may be the ground voltage.

Thus, an x output voltage Vx according to the x coordinate of the contact position P is output through the first signal line 170a and/or the second signal line 170b connected to the detected lower transparent resistance film 150 contacted with the detected upper transparent resistance film 160.

FIG. 6 shows the upper transparent resistance film 160 corresponding to the contact position P as an equivalent circuit. The x output voltage Vx has a relationship with resistances R_r and R_1 as in Equation 1 below.

Vx=V4+|V3−V4|*R_{—}r/(R_{—}r+R_{—}1)

Vx=V3*R_{—}r/(R_{—}r+R_{—}1) (a case of V4=0) (Equation 1)

The resistance R_r is a resistance of a right portion of the upper transparent resistance film 160 with respect to the contact position P, and the resistance R_1 is a resistance of a left portion of the upper transparent resistance film 160 with respect to the contact position P. These resistances of the lower transparent resistance film 150 and the upper transparent resistance film 160 according to the contact position P may be initially measured and stored in a lookup table. The x coordinate of the contact position P has a one-to-one correspondence relationship with one of the resistance R_1, the resistance R_r, the x output voltage Vx, and the difference between the x output voltage Vx and the third voltage V3 or the fourth voltage V4.

Accordingly, the x coordinate of the contact position P may be obtained by converting the difference between the third voltage V3 or the fourth voltage V4 and the detected x output voltage Vx or the resistance R_r obtained from Equation 1.

Referring to FIG. 7, the application of the fourth voltage V4 to the fourth signal line 180b connected to the detected upper transparent resistance film 160 is maintained, and the third voltage V3 is applied to the first signal line 170a or the second signal line 170b connected to the detected lower transparent resistance film 150. Here, the third voltage V3 may be the same as the first voltage V1, and the fourth voltage V4 may be the same as the second voltage V2 or may be the ground voltage.

Thus, a y output voltage Vy according to the y coordinate of the contact position P is output through the third signal line 180a connected to the detected upper transparent resistance film 160.

FIG. 8 shows a lower transparent resistance film 150 and an upper transparent resistance film 160 corresponding to the contact position P as an equivalent circuit. The y output voltage Vy has a relationship with resistances R_r and R_u as in Equation 2 below.

Vy=V4+|V3−V4|*R_{—}r/(R_{—}r+R_{—}u)

Vy=V3*R_{—}r/(R_{—}r+R_{—}u) (a case of V4=0) (Equation 2)

The resistance R_r is a resistance of a right portion of the upper transparent resistance film 160 with respect to the contact position P, and the resistance R_u is a resistance of an upper portion of the lower transparent resistance film 150 with respect to the contact position P. Accordingly, the y output voltage Vy depends on the resistance R_r, that is, the x coordinate of the contact position P, and the y coordinate of the contact position P has a one-to-one correspondence relationship with one of the resistance R_u, the y output voltage Vy, and the difference between the third voltage V3 or the fourth voltage V4 and the y output voltage Vy in the state that the resistance R_r is determined.

Accordingly, the y coordinate of the contact position P may be obtained by converting the difference between the third voltage V3 or the fourth voltage V4 and the detected y output voltage Vy or the resistance R_u by Equation 2 in the state that the resistance R_r is determined.

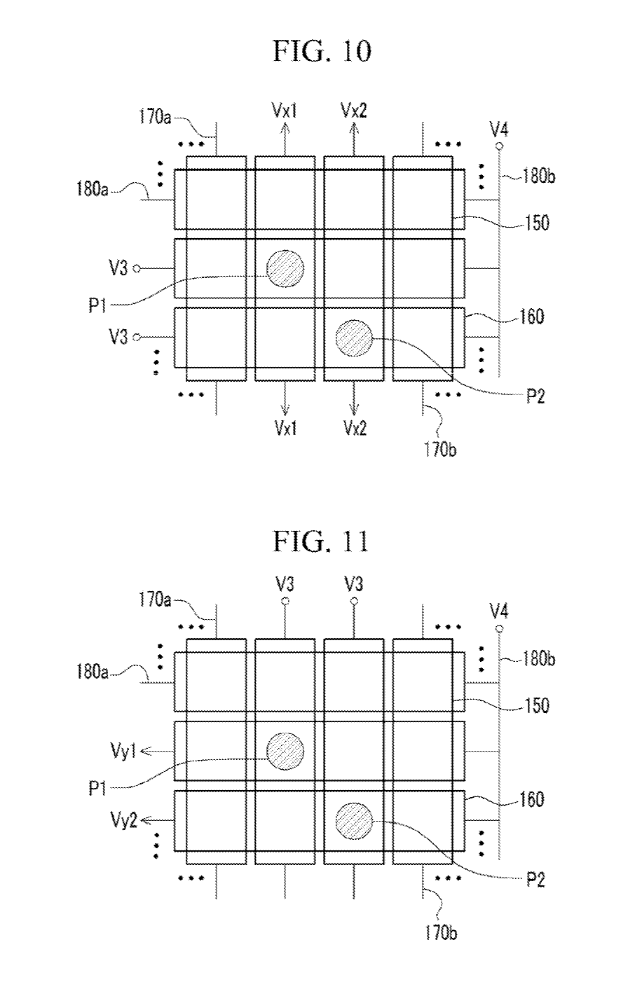

A method for detecting a contact position when two or more portions of a touch panel according to an exemplary embodiment of the present invention are contacted will be described with reference to FIG. 9, FIG. 10, and FIG. 11. Like reference numerals are assigned to the same constituent elements as in FIG. 1 to FIG. 8, and the same description is omitted.

FIG. 9, FIG. 10, and FIG. 11 are views sequentially showing a method for detecting contact positions when two portions of a touch panel according to an exemplary embodiment of the present invention are contacted.

Referring to FIG. 9, the first voltage V1 is input through the first signal lines 170a of the lower transparent resistance films 150, and the fourth terminals of the upper transparent resistance films 160 is input with the second voltage V2 through the fourth signal line 180b as a common wire.

If contacts are applied to two contact positions P1 and P2 of the touch panel, the first detecting voltages V1′ are detected through the second signal lines 170b connected to the lower transparent resistance films 150 of the two contact positions P1 and P2, and the second detecting voltages V2′ are detected through the third signal lines 180a connected to the upper transparent resistance films 160 of the two contact positions P1 and P2.

Accordingly, the detected lower transparent resistance films 150 and the detected upper transparent resistance films 160 corresponding to two contact positions P1 and P2 may be detected.

Referring to FIG. 10, the third voltage V3 is applied to the third signal lines 180a connected to the detected upper transparent resistance films 160 and the fourth voltage V4 is applied to the fourth signal line 180b, and the first x output voltage Vx1 and the second x output voltage Vx2 according to the x coordinate of the two contact positions P1 and P2 are detected through the first signal lines 170a or the second signal lines 170b connected to the detected lower transparent resistance films 150.

Referring to FIG. 11, the application of the fourth voltage V4 to the fourth signal line 180b connected to the detected upper transparent resistance films 160 is maintained, and the third voltage V3 is applied to the first signal lines 170a or the second signal lines 170b connected to the detected lower transparent resistance films 150. Thus, the first y output voltage Vy1 and the second y output voltage Vy2 according to the y coordinate of two contact positions P1 and P2 are detected through the third signal lines 180a connected to the detected upper transparent resistance films 160.

Characteristics of exemplary embodiments shown in FIG. 4 to FIG. 8 may be applied to exemplary embodiments shown in FIG. 9 to FIG. 11. Also, differently from exemplary embodiments described in connection with FIG. 9 to FIG. 11, the x and y coordinates of the contact position may also be obtained by a similar method when three positions or more of the touch panel are contacted.

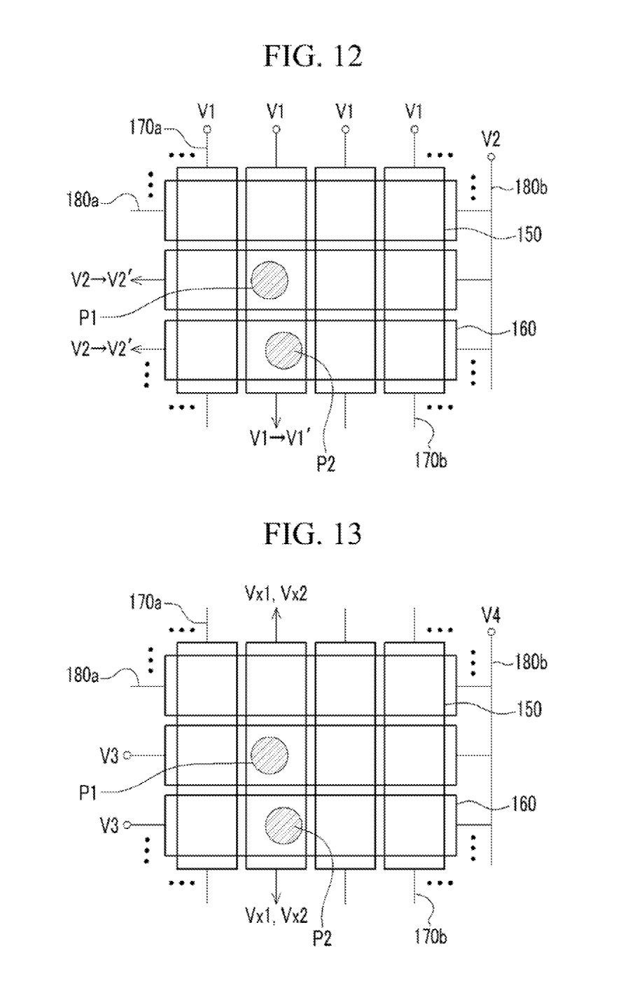

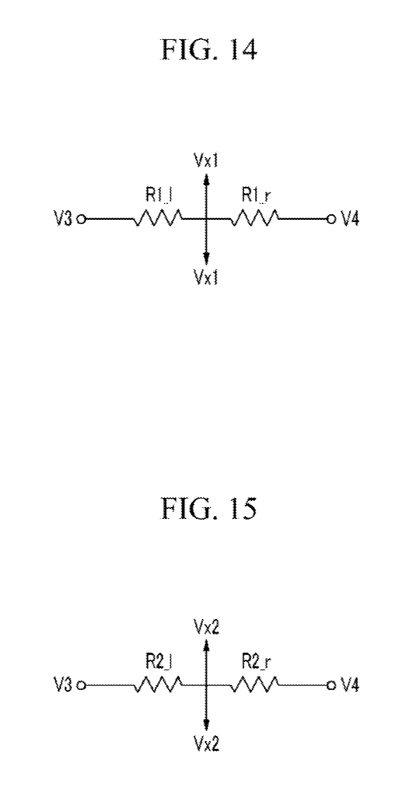

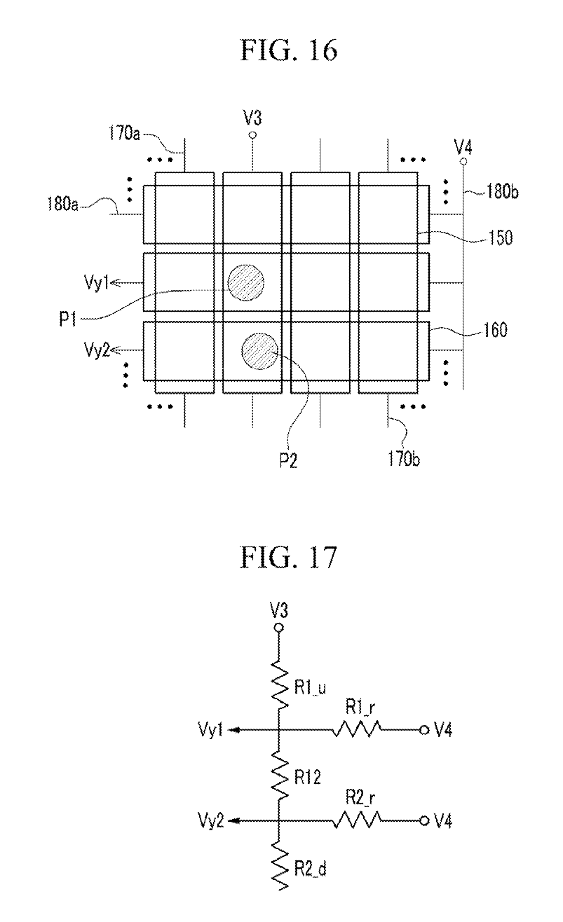

A method for detecting a contact position when two or more portions of a touch panel according to another exemplary embodiment of the present invention are contacted will be described with reference to FIG. 12, FIG. 13, FIG. 14, FIG. 15, FIG. 16, and FIG. 17. Like reference numerals are assigned to the same constituent elements as in FIG. 1 to FIG. 11, and the same description is omitted.

FIG. 12, FIG. 13, and FIG. 16 are views sequentially showing a method for detecting contact positions when two portions of a touch panel according to an exemplary embodiment of the present invention is contacted. FIG. 14 and FIG. 15 are equivalent circuit diagrams to obtain an x coordinate of the contacted position of FIG. 13. FIG. 17 is an equivalent circuit diagram to obtain a y coordinate of the contacted position of FIG. 16. Like reference numerals are assigned to the same constituent elements as in FIG. 4 to FIG. 8 and FIG. 9 to FIG. 11, and the same description is omitted.

According to an exemplary embodiment, when two or more positions of the touch panel are contacted, and the two contact positions simultaneously correspond to one lower transparent resistance film 150 on one upper transparent resistance film 160.

Referring to FIG. 12, the first voltage V1 is input through the first signal lines 170a of lower transparent resistance films 150, and the fourth terminals of the upper transparent resistance films 160 are applied with the second voltage V2 through the fourth signal line 180b as a common wire.

If two contact positions P1, and P2 of the touch panel are applied with contacts such that the lower transparent resistance film 150 and upper transparent resistance films 160 are contacted with each other, the first detecting voltage V1′ is detected through the second signal line 170b connected to the lower transparent resistance film 150 to which the two contact positions P1 and P2 simultaneously correspond, and the second detecting voltages V2′ are detected through the third signal lines 180a connected to the upper transparent resistance films 160 respectively corresponding to the two contact positions P1 and P2.

Accordingly, one lower transparent resistance film 150 and two upper transparent resistance films 160 corresponding to the two contact positions P1 and P2 may be detected.

Referring to FIG. 13, the third signal lines 180a connected to the two detected upper transparent resistance films 160 are sequentially applied with the third voltage V3, and the fourth signal line 180b is applied with the fourth voltage V4. The first x output voltage Vx1 and the second x output voltage Vx2 of the two contact positions P1 and P2 are respectively and sequentially detected through the first signal line 170a or the second signal line 170b connected to the detected lower transparent resistance film 150.

FIG. 14 represents the upper transparent resistance film 160 corresponding to the contact position P1 as an equivalent circuit. The first x output voltage Vx1 has a relationship with resistances R1_r and R1_1 as in Equation 3 below.

Vx1=V4+|V3−V4|*R1_{—}r/(R1_{—}r+R1_{—}1)

Vx1=V3*R1_{—}r/(R1_{—}r+R1_{—}1) (a case of V4=0) (Equation 3)

The resistance R_r is a resistance of a right portion of the upper transparent resistance film 160 with respect to the contact position P1, and the resistance R_1 is a resistance of a left portion of the upper transparent resistance film 160 with respect to the contact position P1. The x coordinate of the contact position P1 has a one-to-one correspondence relationship with one of the resistance R1_1, the resistance R1_r, the first x output voltage Vx1, and the difference between the first x output voltage Vx1 and the third voltage V3 or the fourth voltage V4.

Accordingly, the x coordinate of the contact position P1 may be obtained by converting the difference between the third voltage V3 or the fourth voltage V4 and the detected first x output voltage Vx1 or the resistance R1_r obtained from Equation 3.

FIG. 15 represents the upper transparent resistance film 160 corresponding to the contact position P2 as an equivalent circuit. The second x output voltage Vx2 has a relationship as in Equation 4 with resistances R2_r and R2_1.

Vx2=V4+|V3−V4|*R2_{—}r/(R2_{—}r+R2_{—}1)

Vx2=V3*R2_{—}r/(R2_{—}r+R2_{—}1) (a case of V4=0) (Equation 4)

The resistance R2_r is a resistance of a right portion of the upper transparent resistance film 160 with respect to the contact position P2, and the resistance R2_1 is a resistance of a left portion of the upper transparent resistance film 160 with respect to the contact position P2. The x coordinate of the contact position P2 has a one-to-one correspondence relationship with one of the resistance R2_1, the resistance R2_r, the second x output voltage Vx2, and the difference between the second x output voltage Vx2 and the third voltage V3 or the fourth voltage V4.

Accordingly, the x coordinate of the contact position P2 may be obtained by the difference between the third voltage V3 or the fourth voltage V4 and the detected second x output voltage Vx2 or the resistance R2_r obtained from Equation 4.

Referring to FIG. 16, while the application of the fourth voltage V4 to the fourth signal line 180b connected to the detected upper transparent resistance films 160 is maintained, the first signal line 170a or the second signal line 170b connected to the one detected lower transparent resistance film 150 is applied with the third voltage V3.

The first y output voltage Vy1 and the second y output voltage Vy2 of the contact positions P1 and P2 are detected through the third signal lines 180a connected to the two detected upper transparent resistance films 160.

FIG. 17 represents the one lower transparent resistance film 150 and two upper transparent resistance films 160 corresponding to the contact positions P1 and P2 as an equivalent circuit. The first y output voltage Vy1 and the second y output voltage Vy2 have a relationship as in Equation 5 below.

Vy1=V4+|V3−V4|*R1_{—}r(R12+R2_{—}r)/{R1_{—}u(R12+R1_{—}r+R2_{—}r)+R1_{—}r(R12+R2_{—}r)}

Vy1=V3*R1_{—}r(R12+R2_{—}r)/{R1_{—}u(R12+R1_{—}r+R2_{—}r)+R1_{—}r(R12+R2_{—}r)} (a case of V4=0)

Vy2=V4+|V3−V4|*R1_{—}r*R2_{—}r/{R1_{—}u(R12+R1_{—}r+R2^{—}r)+R1_{—}r(R12+R2_{—}r)}

Vy2=V3*R1_{—}r*R2_{—}r/{R1_{—}u(R12+R1_{—}r+R2_{—}r)+R1_{—}r(R12+R2_{—}r)} (a case of V4=0) (Equation 5)

The resistance R1_r is a resistance of a right portion of the upper transparent resistance film 160 with respect to the contact position P1, the resistance R2_r is a resistance of a right portion of the upper transparent resistance film 160 with respect to the contact position P2, the resistance R1_u is a resistance of an upper portion of the lower transparent resistance film 150 with respect to the contact position P1, the resistance R2_d is a resistance of a lower portion of the lower transparent resistance film 150 with respect to the contact position P2, and the resistance R12 is a resistance of the lower transparent resistance film 150 between two contact positions P1 and P2.

Accordingly, the first y output voltage Vy1 and the second y output voltage Vy2 depend on the resistances R1_r and R2_r, that is, the x coordinates of the contact positions P1 and P2. The y coordinate of the contact position P1 has a one-to-one correspondence relationship with one of the resistance R1_u, the first y output voltage Vy1, and the difference between the third voltage V3 or the fourth voltage V4 and the first y output voltage Vy1 in the state that the resistances R1_r and R2_r are determined, and the y coordinate of the contact position P2 has a one-to-one correspondence relationship with one of the resistance R12, the second y output voltage Vy2, and the difference between the third voltage V3 or the fourth voltage V4 and the second y output voltage Vy2 in the state that the resistances R1_r, R2_r and R1_u are determined.

Accordingly, the y coordinates of the contact positions P1 and P2 may be obtained by converting the difference between the third voltage V3 or the fourth voltage V4 and the detected first y output voltage Vy1 and the detected second y output voltage Vy2, respectively, or the resistance R1_u and the resistance R12 by Equation 5, respectively, in the state that the resistances R1_r and R2_r are determined.

Characteristics of exemplary embodiments shown in FIG. 4 to FIG. 8 may be applied to exemplary embodiments shown in FIG. 12 to FIG. 17.

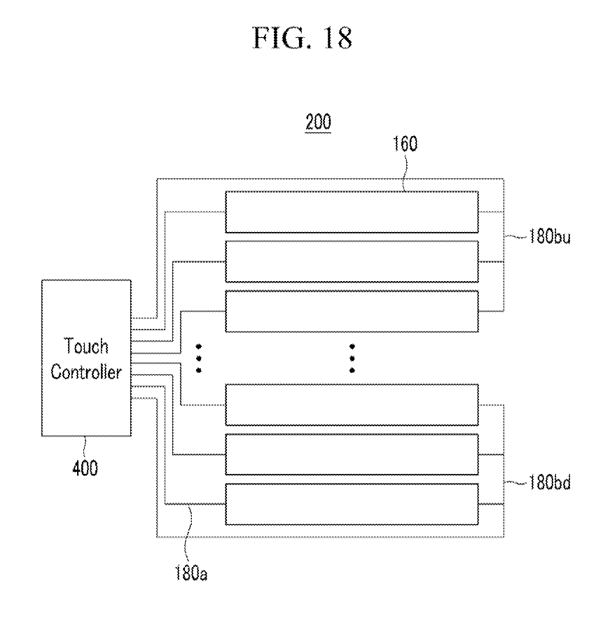

A touch panel according to another exemplary embodiment of the present invention will be described with reference to FIG. 18. Like reference numerals are assigned to the same constituent elements as in FIG. 1 to FIG. 17, and the same description is omitted.

FIG. 18 is a top plan view of an upper substrate of a touch panel according to an exemplary embodiment of the present invention.

Referring to FIG. 18, the upper transparent resistance films 160 of the upper substrate 200 of the touch panel according to an exemplary embodiment of the present invention are divided into a plurality of blocks, wherein one block is connected to the touch controller 400 through the upper fourth signal line 180bu of which the right terminals are connected into one, and another block is connected to the touch controller 400 through the lower fourth signal line 180bd of which the right terminals are connected into one. The number of upper transparent resistance films 160 included in two blocks may be the same. Characteristics of the various exemplary embodiments may be applied to exemplary embodiments shown in FIG. 18.

In this structure, the detecting speed of the multi-touch may be increased, and the contact position detecting method may be simplified when multi-touch is generated throughout the different blocks.

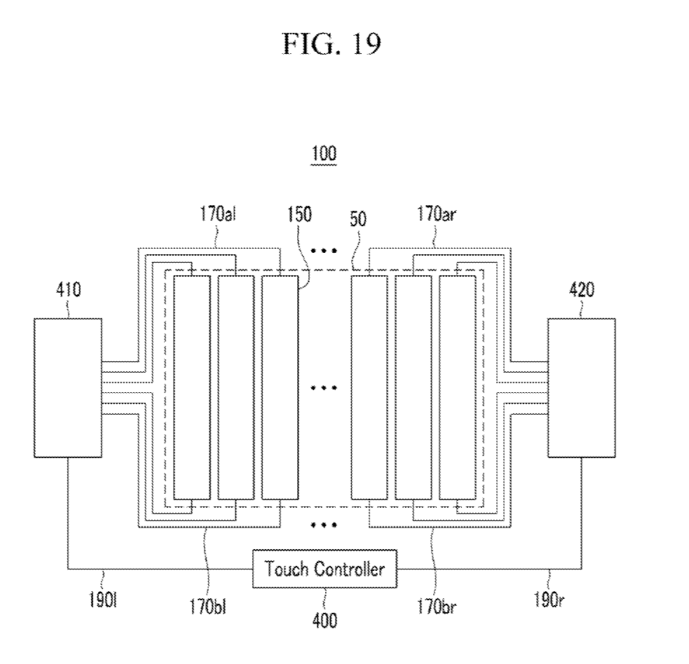

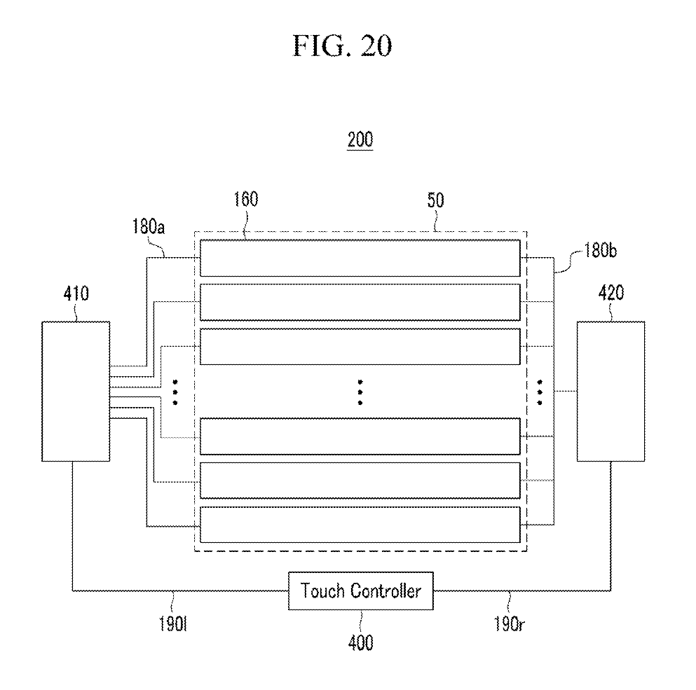

A touch panel according to another exemplary embodiment of the present invention will be described with reference to FIG. 19 and FIG. 20. Like reference numerals are assigned to the same constituent elements as in the previous exemplary embodiment, and the same description is omitted.

FIG. 19 is a top plan view of a lower substrate of a touch panel according to an exemplary embodiment of the present invention, and FIG. 20 a top plan view of an upper substrate of a touch panel according to an exemplary embodiment of the present invention. Referring to FIG. 19, differently from FIG. 2, the lower transparent resistance films 150 formed in the lower substrate 100 of the touch panel according to an exemplary embodiment of the present invention are divided into a plurality of blocks, and the first terminals as the upper terminals of the lower transparent resistance films 150 included in one block, as an example in the left block, are connected to a first connection circuit portion 410 through the left first signal lines 170al, and the second terminals as the lower terminals of the lower transparent resistance films 150 are connected to the first connection circuit portion 410 through the left second signal lines 170bl. In another block, for example in the right block, the first terminals of the lower transparent resistance films 150 are connected to a second connection circuit portion 420 through the right first signal lines 170ar, and the second terminals are connected to the second connection circuit portion 420 through the right second signal lines 170br. The first connection circuit portion 410 and the second connection circuit portion 420 may be various types such as a flexible printed circuit film (FPC) or a printed circuit board (PCB). The first and second connection circuit portions 410 and 420 are connected to the touch controller 400 through signal lines 190l and 190r.

Referring to FIG. 20, the upper transparent resistance films 160 formed in the upper substrate 200 of the touch panel according to an exemplary embodiment of the present invention are the same as in exemplary embodiments of FIG. 3. Here, the third signal lines 180a respectively connected to the third terminals as the left terminals of the upper transparent resistance films 160 are connected to the first connection circuit portion 410, and the fourth signal line 180b as the common wire connected to the fourth terminal as the right terminal of the upper transparent resistance films 160 is connected to the second connection circuit portion 420. As shown in FIG. 19, the first connection circuit portion 410 and the second connection circuit portion 420 are connected to the touch controller 400 through the signal lines 190l and 190r.

As described above, the signal lines 170al, 170ar, 170bl, and 170br connecting the lower transparent resistance films 150 to the touch controller 400 through the connection circuit portions 410 and 420 are not gathered, but are divided into a plurality of portions, and are connected to the touch controller 400, such that the display area 50 of the touch panel may be further increased and the peripheral area around of the display area 50 may be further reduced in a given device area including the display area 50 and the peripheral area.

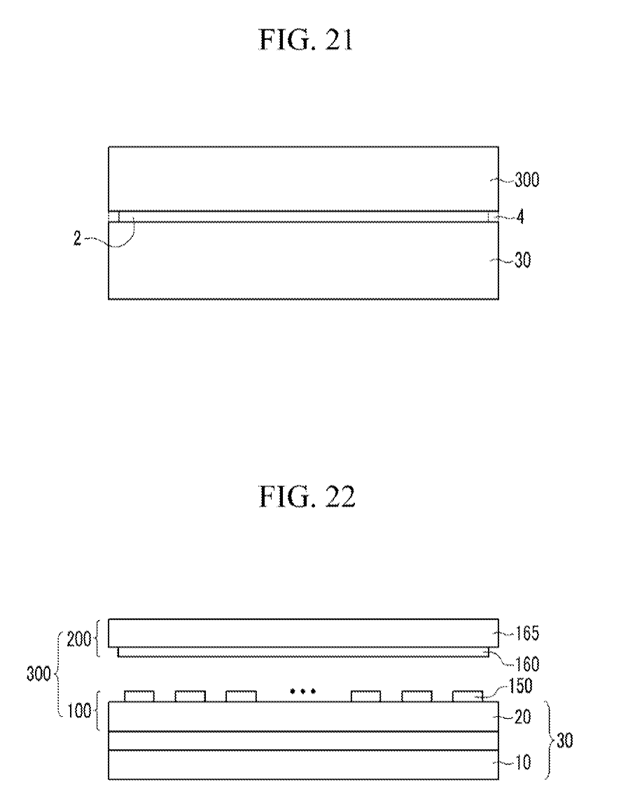

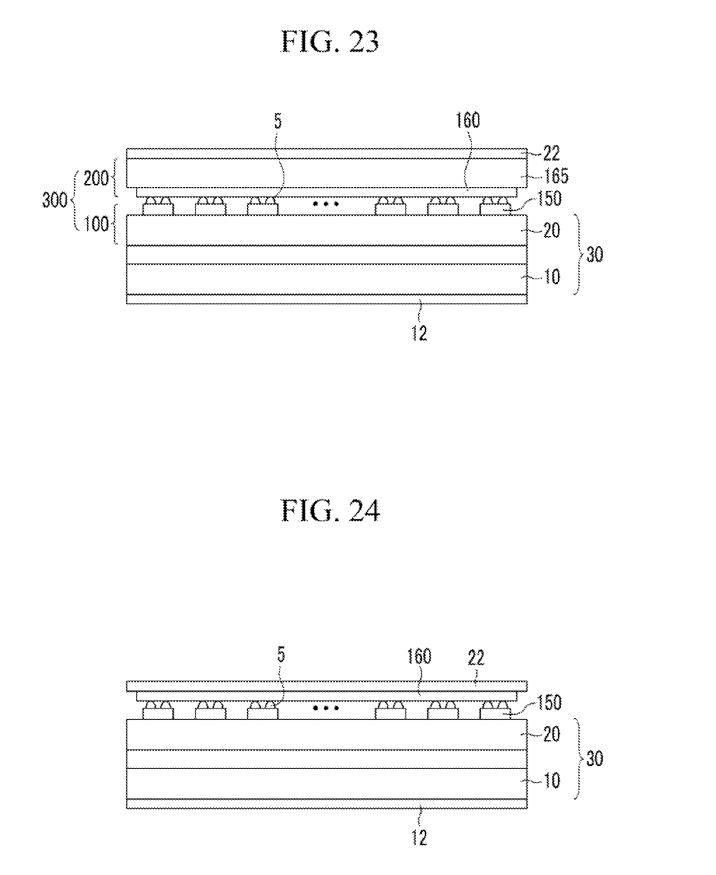

A display device attached with the touch panel or including the touch panel according to an exemplary embodiment of the present invention will be described with reference to FIG. 21, FIG. 22, FIG. 23, and FIG. 24.

FIG. 21 is a cross-sectional view of a display panel to which a touch panel is attached according to an exemplary embodiment of the present invention, and FIG. 22, FIG. 23, and FIG. 24 are cross-sectional views of a display panel installed with a touch panel according to an exemplary embodiment of the present invention.

Referring to FIG. 21, a touch panel 300 according to a an exemplary embodiment of the present invention is attached on a display device 30 such as a liquid crystal display or an organic light emitting device by an adhesion member 4. Here, a space 2 may be formed between the display device 30 and the touch panel 300. According to an exemplary embodiment, display of a display device 30 may be controlled according the contact position information of the contact of the touch panel 300.

Referring to FIG. 22 and FIG. 23, the display device 30 according to another exemplary embodiment of the present invention includes two substrates 10 and 20 facing each other. A liquid crystal layer (not shown) or an emission layer (not shown) may be positioned between two substrates 10 and 20, and elements to display images such as color filters (not shown) or a common electrode (not shown) receiving a common voltage Vcom may be formed on the inner surface of the upper substrate 20.

The lower transparent resistance films 150 of the touch panel 300 as described in several exemplary embodiments are formed on the outer surface of the upper substrate of the display device 30, and the upper substrate 200 of the touch panel 300 is positioned thereon. Accordingly, the upper substrate 20 of the display device 30 has a function of the lower substrate 100 of the touch panel 300.

The upper substrate 200 of the touch panel 300 includes the upper transparent resistance films 160 formed on an upper film 165. The upper film 165 of the touch panel 300 may be made of an optically isotropic material along with the upper substrate 20 of the display device 30.

Referring to FIG. 23, a lower polarizer 12 is attached on the outer surface of the lower substrate 10 of the display device 30, and an upper polarizer 22 is attached on the outer surface of the upper substrate 200 of the touch panel 300. In this case, the lower and upper polarizers 12 and 22 control the polarization of the incident light or the emitted light in the case that the display device 30 is a display device displaying images according to polarization of the light, such as a liquid crystal display.

As shown in FIG. 23, a spacer 5 for maintaining the interval between the upper substrate 200 and the lower substrate 100 and to substantially prevent a short therebetween is formed on an inner surface of one of the upper substrate 200 and the lower substrate 100 of the touch panel 300.

The touch panel according to FIG. 22 and FIG. 23 has a thinner thickness than the touch panel according to FIG. 21, and therefore may improve the sensitivity of the touch.

Referring to FIG. 24, differently from FIG. 23, the upper transparent resistance films 160 of the upper substrate 200 of the touch panel 300 are formed directly on the upper polarizer 22 which is optically isotropic. Thus, the upper film that is optically isotropic and thus highly cost is not required such that the manufacturing process of the touch panel may be simplified and the manufacturing cost may be reduced.

Differently from FIG. 23 and FIG. 24, the lower polarizer 12 and the upper polarizer 22 may be included in the display device 30 as constituent elements forming the display device 30.

The characteristics of the touch panel according to several exemplary embodiments may be applied to exemplary embodiments of FIG. 21, FIG. 22, FIG. 23, and FIG. 24.

Differently from several exemplary embodiments of the present invention, the structures of the lower substrate 100 and the upper substrate 200 of the touch panel may be exchanged, and the terminals at one side of lower transparent resistance films 150 of the lower substrate 100 may be connected to the touch controller 400 through one common wire, differently from several exemplary embodiments of the present invention.

The various characteristics of the present invention may be applied to a touch panel having different structures.

According to an exemplary embodiment of the present invention, the signal lines connected to the terminals at one side of the plurality of transparent resistance films formed in the lower substrate or the upper substrate of the touch panel are formed as one common wire, such that the peripheral area of the touch panel may be reduced and the display area may be increased in a given device area including the display area and the peripheral area.

Also, according to an exemplary embodiment of the present invention, the contact positions for the multi-touch may be easily detected.

Also, the lower transparent resistance films of the touch panel may be directly formed on the upper substrate of the display device or the upper transparent resistance films may be directly formed on the upper polarizer of the display device, such that the manufacturing process may be simplified and the thickness of the display device including the touch panel may be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A touch panel comprising:
a first substrate and a second substrate facing each other;
a plurality of first transparent resistance films formed on the first substrate and extending in a first direction;
a plurality of second transparent resistance films formed on the second substrate and extending in a second direction;
a plurality of first signal lines respectively connected to first terminals at first ends of the plurality of first transparent resistance films;
a plurality of second signal lines respectively connected to second terminals at second ends of the plurality of first transparent resistance films;
a plurality of third signal lines respectively connected to third terminals at first ends of the plurality of second transparent resistance films; and
a fourth signal line commonly connected to fourth terminals at second ends of at least two second transparent resistance films among the plurality of the second transparent resistance films,
wherein the first direction and the second direction cross each other.

2. The touch panel of claim 1, wherein
a deviation of the voltages applied to the fourth terminals of the at least two second transparent resistance films from the fourth signal line is equal to or less than 3%.

3. The touch panel of claim 1, wherein
the fourth signal line is connected to the fourth terminals of the plurality of second transparent resistance films.

4. The touch panel of claim 1, wherein
voltages applied to the fourth terminals of the at least two second transparent resistance films from the fourth signal line are the same.

5. The touch panel of claim 1, wherein
at least one of a deviation of resistance of the plurality of first signal lines, a deviation of resistance of the plurality of second signal lines, a deviation of resistance of the plurality of third signal lines, and a deviation of resistance of the fourth signal line is equal to or less than 3%.

6. The touch panel of claim 1, wherein
a line width of at least one of the plurality of first signal lines, the plurality of second signal lines, the plurality of third signal lines, and the fourth signal line is equal to or less than 100 μm.

7. The touch panel of claim 1, further comprising
a spacer positioned between the plurality of first transparent resistance films and the plurality of second transparent resistance films.

8. The touch panel of claim 1, wherein
the second substrate comprises a transparent film.

9. The touch panel of claim 1, wherein
at least one of the plurality of first signal lines, the plurality of second signal lines, the plurality of third signal lines, and the fourth signal line comprises aluminum (Al), silver (Ag), copper (Cu), molybdenum (Mo), chromium (Cr), tantalum (Ta), titanium (Ti) or alloys thereof.

10. The touch panel of claim 1, wherein
at least one of the plurality of first signal lines, the plurality of second signal lines, and the plurality of third signal lines is divided into a plurality of groups, and the signal lines of each group are respectively connected to a plurality of connection circuit portions, and
the fourth signal line is divided into a plurality of portions and the plurality of portions of the fourth signal line are respectively connected to the plurality of connection circuit portions.

11. The touch panel of claim 10, wherein
the connection circuit portions are connected to a touch controller controlling the touch panel.

12. A display device comprising:
a lower substrate and an upper substrate facing each other;
a plurality of first transparent resistance films formed on an outer surface of the upper substrate and extending in a first direction, the outer surface of the upper substrate not facing the lower substrate;
a plurality of second transparent resistance films facing the outer surface of the upper substrate and extending in a second direction intersecting the first direction;
a plurality of first signal lines respectively connected to first terminals at first ends of the plurality of first transparent resistance films;
a plurality of second signal lines respectively connected to second terminals at second ends of the plurality of first transparent resistance films;
a plurality of third signal lines respectively connected to third terminals at first ends of the plurality of second transparent resistance films; and
a fourth signal line commonly connected to fourth terminals at second ends of at least two second transparent resistance films among the plurality of the second transparent resistance films.

13. The display device of claim 12, wherein
a deviation of the voltages applied to the fourth terminals of the at least two of the second transparent resistance films from the fourth signal line is equal to or less than 3%.

14. The display device of claim 12, further comprising
a first polarizer positioned on an outer surface of the lower substrate not facing the upper substrate, and a second polarizer positioned on an outer surface of the second transparent resistance films not facing the outer surface of the upper substrate.

15. The display device of claim 14, further comprising
a first substrate facing the outer surface of the upper substrate, and
the plurality of second transparent resistance films are formed on the first substrate.

16. The display device of claim 14, wherein
the plurality of second transparent resistance films are directly formed on the second polarizer.

17. The display device of claim 12, further comprising
a liquid crystal layer or an emission layer positioned between the lower substrate and the upper substrate.

18. A contact position detecting method of a touch panel including a plurality of first transparent resistance films extending in a first direction and a plurality of second transparent resistance films facing the plurality of first transparent resistance films and extending in a second direction intersecting the first direction, wherein the first transparent resistance films respectively include a first terminal and a second terminal at respective ends thereof, the second transparent resistance films respectively include a third terminal and a fourth terminal at respective ends thereof, and the fourth terminals of the plurality of second transparent resistance films are commonly connected to a first signal line, the method comprising:
commonly applying a first voltage to the fourth terminals of the plurality of second transparent resistance films through the first signal line;
detecting a detected first transparent resistance film corresponding to a first portion where a contact is applied among the plurality of first transparent resistance films;
detecting a detected second transparent resistance film corresponding to the first portion among the plurality of second transparent resistance films;
finding a coordinate in the first direction of the first portion; and
finding a coordinate in the second direction of the first portion.

19. The contact position detecting method of claim 18, wherein
the detecting of the detected first transparent resistance film includes:
applying a second voltage that is different from the first voltage to the first terminals of the plurality of first transparent resistance films while commonly applying the first voltage to the fourth terminals of the plurality of second transparent resistance films through the first signal line; and
detecting voltages of the second terminals of the plurality of first transparent resistance films.

20. The contact position detecting method of claim 19, wherein
the detecting of the detected second transparent resistance film includes:
applying the second voltage to the first terminals of the plurality of first transparent resistance films while commonly applying the first voltage to the fourth terminals of the plurality of second transparent resistance films through the first signal line; and
detecting voltages of the third terminals of the plurality of second transparent resistance films.

21. The contact position detecting method of claim 20, wherein
the finding of the coordinate in the second direction of the first portion includes:
applying a third voltage to the third terminal of the detected second transparent resistance film while commonly applying the first voltage to the fourth terminals of the plurality of second transparent resistance films through the first signal line; and
detecting a voltage of the first terminal of the detected first transparent resistance film or the second terminal of the detected first transparent resistance film.

22. The contact position detecting method of claim 21, wherein
the finding of the coordinate in the first direction of the first portion includes:
applying a fourth voltage to the first terminal of the detected first transparent resistance film while commonly applying the first voltage to the fourth terminals of the plurality of second transparent resistance films through the first signal line; and
detecting a voltage of the third terminal of the detected second transparent resistance film.

23. The contact position detecting method of claim 18, wherein
the first voltage is a ground voltage.

24. The contact position detecting method of claim 22, wherein
the third voltage and the fourth voltage are the same.

25. The contact position detecting method of claim 18, wherein
the finding of the coordinate in the second direction of the first portion includes:
applying a third voltage to the third terminal of the detected second transparent resistance film while commonly applying the first voltage to the fourth terminals of the plurality of second transparent resistance films through the first signal line; and
detecting a voltage of the first terminal of the detected first transparent resistance film or the second terminal of the first transparent resistance film.

26. The contact position detecting method of claim 25, wherein
the finding of the coordinate in the first direction of the first portion includes:
applying a fourth voltage to the first terminal of the detected first transparent resistance film while commonly applying the first voltage to the fourth terminals of the plurality of second transparent resistance films through the first signal line; and
detecting a voltage of the third terminal of the detected second transparent resistance film.

27. The contact position detecting method of claim 26, wherein
the third voltage and the fourth voltage are the same.

28. The contact position detecting method of claim 18, wherein
a deviation of voltages applied to the fourth terminals of the plurality of second transparent resistance films from the first signal line is equal to or less than 3%.

29. The contact position detecting method of claim 18, wherein
the touch panel includes:
a plurality of second signal lines respectively connected to the first terminals of the plurality of first transparent resistance films;
a plurality of third signal lines respectively connected to the second terminals of the plurality of first transparent resistance films; and
a plurality of fourth signal lines respectively connected to the third terminals of the plurality of second transparent resistance films.

30. The contact position detecting method of claim 29, wherein
at least one of a deviation of resistance of the plurality of second signal lines, a deviation of resistance of the plurality of third signal lines, and a deviation of resistance of the fourth signal lines is equal to or less than 3%.
